(19) United States
(12) Patent Application Publication
(10) Pub. No.: US 2018/0161892 A1
(43) Pub. Date: Jun. 14, 2018

(54) DEVICE FOR MEASURING AND MAKING MITER JOINTS

(71) Applicant: Nicholas James Iglehart, Louisburg, NC (US)

(72) Inventor: Nicholas James Iglehart, Louisburg, NC (US)

(21) Appl. No.: 15/378,533

(22) Filed: Dec. 14, 2016

(51) Int. Cl. B23D 47/04; B23D 45/14; B27B 27/06

(52) U.S. Cl. CPC B23D 47/04; B27B 27/06; B23D 45/14

(57) ABSTRACT

The present invention relates to a tool for measuring angles and corners and cutting trim to those angles.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a mitering tool. In particular, it relates to a mitering tool for measuring angles and corners, and then cutting trim and the like with the measurement.

### Description of Related Art

The cutting of miter cuts using a miter box is well-known, and many devices are available for cutting precise 90 degree angles or a preset angle. When the miter cut is an unusual angle, transfer of the measurements to a separate miter box is subject to extreme times and errors due to the computation or difficulty of the measurement. In addition, these types of devices can be difficult to set precisely.

Accordingly, there have been many attempts to design mitering tools that solve the problem. Unfortunately, they have accomplished this with complex tools with a high number of moving parts, which create problems and can easily break. Having the ability to set the miter cut automatically without an expensive or difficult to use device is still necessary to the trade.

### BRIEF SUMMARY OF THE INVENTION

The present invention relates to the discovery that if two 360 degree locking swivel arms are positioned in spaced relationship to a saw guide, the swivel arms provide an infinite number of positions for cutting miter cuts (in order to make miter joints), and that the problems, cost, and complexity of previous devices can be avoided.

Accordingly, in one embodiment, there is a mitering tool for both measuring an angle and cutting at the measured angle for making joints comprising:
a) a base having a front top, a back top and a bottom, the front top having a recessed center section opening;
b) a saw guide mounted on the base back top for guiding a saw along a saw line when making a cut in a workpiece;
c) a first and second arm mounted on the front top of the base on either side of the center section opening in space relationship to the saw guide, wherein each arm is mounted using a single swivel mounting device positioned on the base to be able to be swiveled and locked in place to measure the angle; and
d) wherein a line between the first and second arm swivel is perpendicular to the saw line.

### BRIEF DESCRIPTION OF THE DRAWINGS

FIG. 1 is a perspective view of the miter tool showing arm swivel.

FIG. 2 is a top view of the invention with two arms being used to measure an exterior angle.

FIG. 3 is a top view of the invention with two arms being used to measure an interior angle.

FIG. 4 is a perspective view of the invention showing the set arms from FIG. 2 with a piece of wood in position for cutting.

FIG. 5 is a side view of the present invention wherein optional extensions are shown.

FIG. 6 shows the present invention measuring the angle of the walls in use with the extensions.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “mitering tool” refers to a device designed for the user to take a power or hand saw and cut pieces (usually wood) into miter cuts for the purpose of making miter joints with the cut pieces. A mitering tool normally comprises a base and a guide for directing the saw blade, and something to position the piece (of wood) such that the appropriate angle of cut can be accomplished. Herein the present invention has two arms, both of which serve for positioning the piece for cutting and measuring angles, say around a wall, and then leaving the guide arms at that position for further cutting purposes.

As used herein, the term “measuring an angle” refers to being able to place the first and second arms against a wall angle, as shown in the drawings, which fixes the arms (tightened and loosened) in the exact angle of the wall angle, which arms can then be used to hold a work piece of wood against and cut proper miter joints of the angle measured. In order to accomplish this, though, the arms must be in spaced relationship to the end of the saw guide.

As used herein, the term “cutting at the measured angle” refers to, as described above, positioning the first and second arm against the wall joint and locking them in place at the angle they make while held against the wall, as shown in the figures.

As used herein, the term “making joints” refers to cutting wood or other materials (plastic for example) in order to join them in a mitered joint, this process is well-known in the art, the device for measuring and cutting is novel.

As used herein, the term “base” refers to simply a board or other flat material for positioning a saw guide and a first and second revolving arm at the proper spaced interval for measuring wall angles. Typically, they are made of wood or metal, and have a top, a bottom, and a top front and a top back. At the front end there is an opening sufficient to allow the front end to be placed on or in a corner without hitting the base, as shown in the Figures.

As used herein, the term “saw guide” refers to a device for guiding a powered or hand saw blade in a straight line for the purpose of cutting a miter joint in a piece of wood or other like material. In one embodiment, the saw guide comprises a pair of half plates that define a long slot to guide a saw blade. Saw guides are within the skill in the art, and substitutions of guides within the scope of the claims are within the skill in the art.

As used herein, the term “first and second arm” refers to material with straight edge long sides, as shown in the drawings. While the short ends can be any shape, the long sides are parallel and straight. The straight edge can thus be placed against a wall, as shown in the drawings, utilizing the top front recessed center section opening. Each of the arms are attached only with a device consisting of a single pivot point, or swivel, mounted to the base, which allows the arm to pivot 360 degrees around that point, and thus match any angle as the device utilizing the top front opening is pushed up against the wall, as shown in the drawings. In order to hold the arms in place after taking the angle, there is a locking device to hold the arms in place that can be on the top or the bottom of the base. The pivot can pass through the base entirely, just be applied on top, or partially applied through the base as desired. While any device could lock the arms in place, in one embodiment the device for locking the arms in place is a pressure latch of a size that does not interfere with the use of the arms or the cutting of a piece up against the arms. The arms are mounted on the front top of the base, on either side of the center section opening, in spaced relationship to one another and in relationship to the saw guide, wherein each arm is mounted, and wherein a line between the first and second arm swivel is perpendicular to the saw line. That perpendicular line is at least one inch, and in one embodiment, 1 to 6 inches away from the saw guide along the saw line. In one embodiment, the arms are positioned to be able to pass over/under one another, as shown in the drawings, to increase the number of angles that the tool can measure.

### DRAWINGS

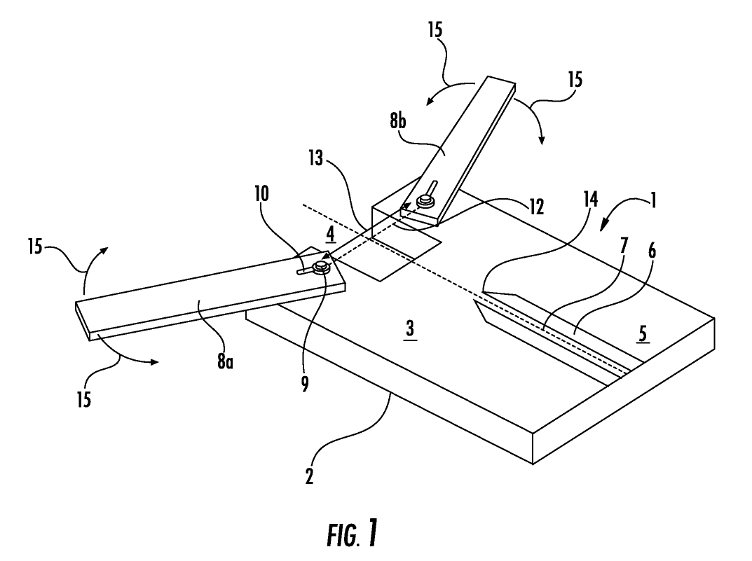

Now referring to the drawings, FIG. 1 is a perspective of the miter tool 1 of the present invention. The tool 1 has base 2 having a top 3, the top 3 having a top front opening 4 and a top back 5. Mounted toward the top back 5 is saw guide 6 which, when used with a saw, has cut line 7. A first arm 8a and second arm 8b are shown mounted only at swivel point 9 next to top front opening 4 which has locking latch 10 for locking the arms in place when desired. The arms 8a and 8b are spaced apart 13 along line 12; line 12 is perpendicular to the cut line 7 and is positioned towards the front opening 4 at least an inch from the closest point 14 of the saw guide 6 along the cut line 7. Arrows 15 indicate the swivel direction possibilities of each arm while top front opening 4 allows the tool to get up to or in wall corners.

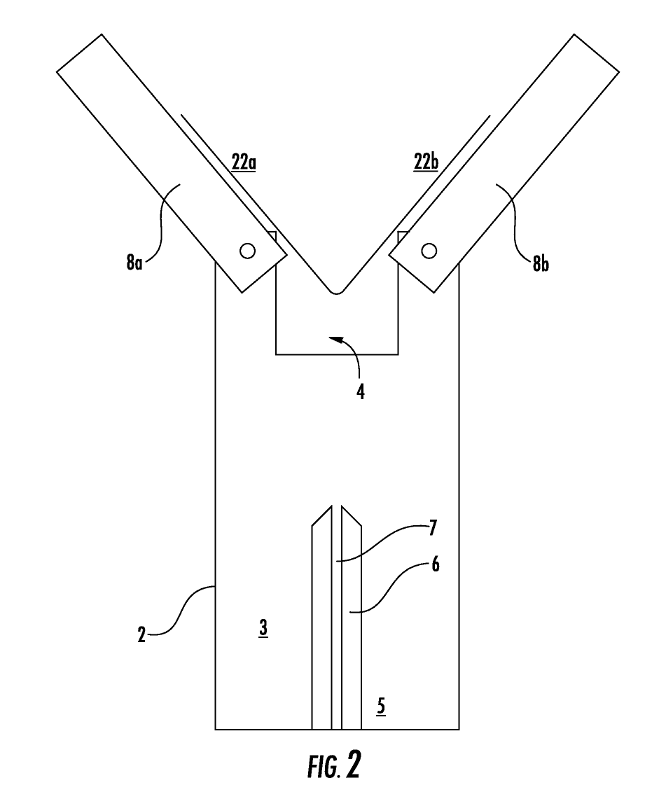

In perspective FIG. 2, the tool 1 has arms 8a and 8b up against walls 22a and 22b, with the wall corner extending into front opening 4. The arms 8a and 8b are locked in place, and thus in alignment with the tool saw line 7.

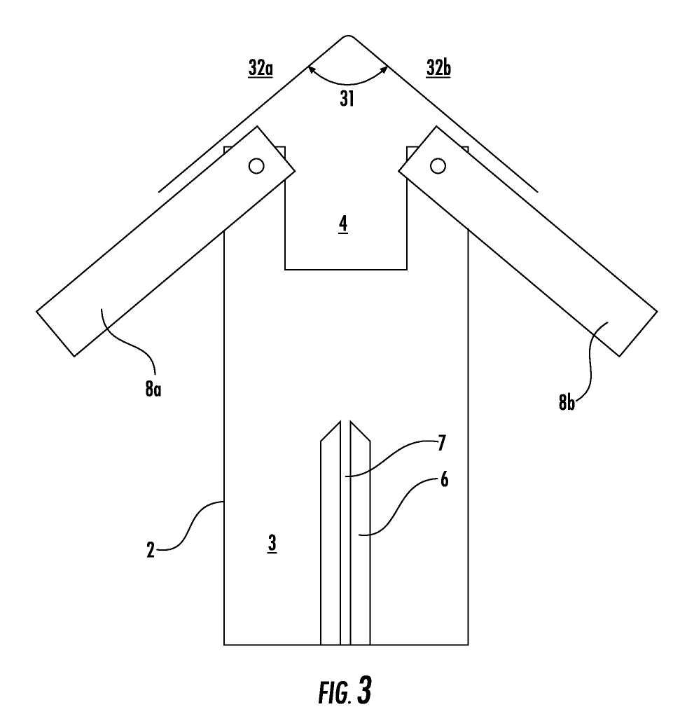

In FIG. 3 an inside angle 31 is shown between walls 32a and 32b and arms 8a and 8b positioned to measure the angle between them.

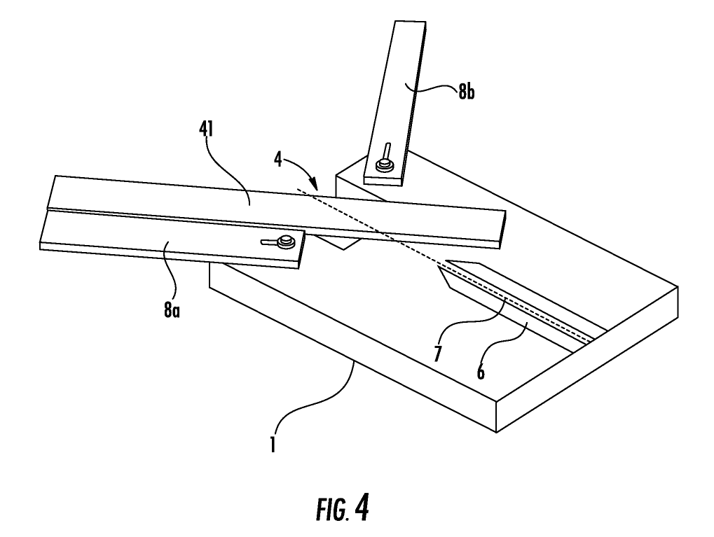

In FIG. 4 it is seen that the board 41 to be cut is then just laid next to the arm 8a for cutting purposes and cut along the cut line 7 and thus the user makes a correct cut on the board.

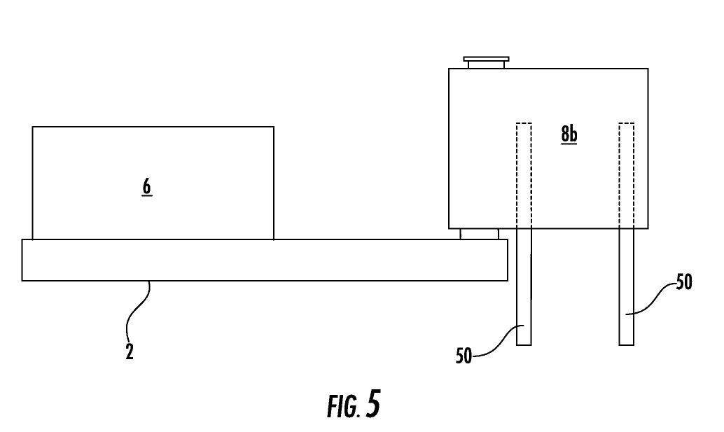

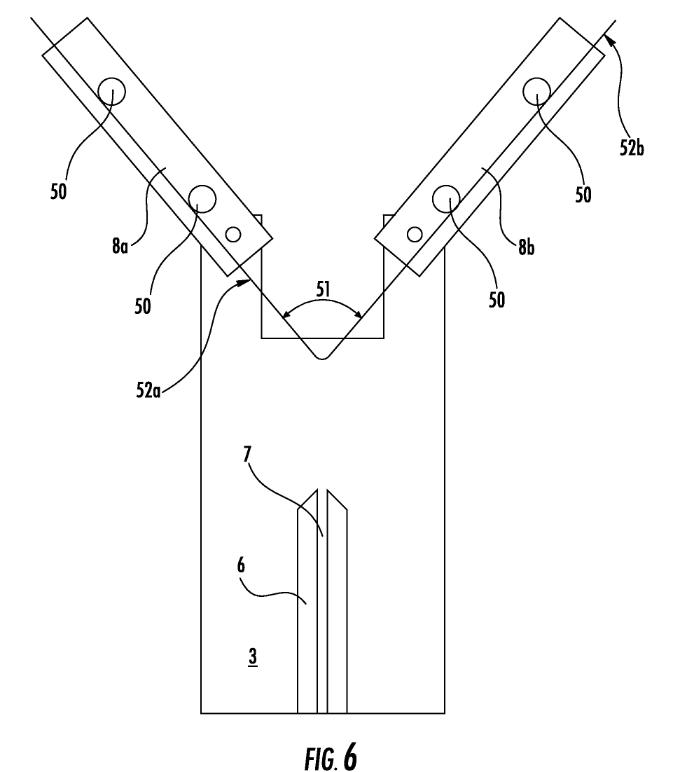

FIG. 5 is a side view of the device 1 wherein optional extensions 50 are shown to raise arms 8a and 8b to measure the angle. FIG. 6 shows the device measuring angle 51 of walls 52a and 52b in use with extensions 50.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A mitering tool for both measuring an angle and cutting at the measured angle for making joints comprising:
a) a base having a front top, a back top and a bottom, the front top having a recessed center section opening;
b) a saw guide mounted on the base back top for guiding a saw along a saw line when making a cut in a workpiece;
c) a first and second arm mounted on the front top of the base on either side of the center section opening in space relationship to the saw guide, wherein each arm is mounted using a single swivel mounting device positioned on the base to be able to be swiveled and locked in place to measure the angle; and
d) wherein a line between the first and second arm swivel is perpendicular to the saw line.

2. The tool according to claim 1 wherein the swivel arms are locked in place with a latch.

3. The tool according to claim 1 wherein the saw guide comprises a pair of half plates that define a long slot to guide a saw blade.

4. The tool according to claim 1 wherein the saw guide is spaced from the first and second arms by about 4 to 12 inches.

5. The tool according to claim 1 wherein the first and second arm are designed to pass over each other while being swiveled.
